(19) United States
(12) Patent Application Publication
(10) Pub. No.: US 2009/0035116 A1
(43) Pub. Date: Feb. 5, 2009

(54) LOAD LIFTING APPARATUS

(76) Inventors: Jack McGowan Johnson, Auburn, AL (US); Walter Benners Vail, JR., Tuskegee, AL (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/025,338

(22) Filed: Feb. 4, 2008

Related U.S. Application Data
(60) Provisional application No. 60/888,168, filed on Feb. 5, 2007.

(51) Int. Cl. B60P 9/00

(52) U.S. Cl. 414/631

(57) ABSTRACT

A device for loading and unloading objects onto a truck including two support members and a rigid substantially L-shaped support. The support members and rigid substantially L-shaped member are subject to force from at least 3 actuators. The operation of actuators maintains the horizontal portion of the rigid L-shaped member in substantially horizontal orientation during the flexion and extension of the joints connecting the members, and the joint connecting the device to the truck.

### RELATED APPLICATION

This application claims priority to U.S. application Ser. No. 60/888,168, filed Feb. 5, 2007, incorporated herein by reference.

### FIELD OF THE PRESENT INVENTION

The present invention relates to the field of loading and/or unloading apparatus, and more particularly to an improved load lifting apparatus that efficiently loads and unloads objects from ground level to a truck bed in a manner such that the load remains substantially horizontal during the lift process.

### BACKGROUND OF THE PRESENT INVENTION

It is customary in the field for objects to be lifted onto truck beds with various loading devices. The loading of objects onto a truck is often carried out by apparatuses external to the truck being loaded, i.e. via forklifts, ramp and dolly arrangements, manpower, etc. Now, trucks can come equipped with their own load lifting apparatus. The load lifting apparatuses contained on trucks are generally either, apparatuses with minimal parts that fail to control the orientation of the object or apparatuses with numerous complicated parts which control the object but cost the truck significant space and weight. Other variations of load lifting apparatuses contained on trucks include numerous complicated parts, but yet fail to control the orientation of the object.

The loading apparatuses that fail to control the object to be loaded generally include a lift and roll system. These lift systems normally lift one end of the object to create an incline, and slide the object on/off using the roller system. The action can by analogized to the operation of a dump truck. The “dumping” of a object is not conducive to lifting objects having valuable material, delicate material, or objects with unsecured internal contents. An object's contents may shift and/or damage during the “dumping.”

Further, loading apparatuses that offer control of an object generally require a substantial number of parts, which subsequently adds weight to the truck carrying the device. The loss of space and the added weight are inefficient in the practice of object transportation. The more free space available on the truck, the larger the object being carried may be. The less weight in the loading apparatus, the more weight that the object may have, and the better gas mileage the truck may have.

Thus, a need exists to overcome the disadvantages listed herein, and to provide an apparatus capable of loading/unloading objects while having control of the orientation of the object, and allowing for highly efficient transportation.

### SUMMARY OF THE PRESENT INVENTION

The present invention provides a apparatus for loading and unloading objects onto a truck including a first support having a first end portion connected with a truck and a second end portion, a first actuator configured to supply force to the first support having a first end portion connected with a truck and a second end portion connected with the first end portion of the first support, a second support having a first end connected with the second end portion of the first support and a second end, a second actuator configured to supply force to the second support having a first end connected with the second end of the first support, wherein said second actuator is in substantial alignment with said second support, a rigid substantially L-shaped support configured to carry an object having a carriage member and a backstop member, the carriage member having a first end portion and a second end portion, and the backstop member having a first end portion and a second end portion, wherein the first end portion of the carriage member is in substantial rigid connection with the second end of the backstop member, and a third actuator configured to supply force to the rigid substantially L-shaped support, having a first end portion and a second end portion, the first end portion of the third actuator connected with the second support and the second end portion of the third actuator connected with the first end of the backstop member, wherein the first actuator, second actuator and third actuator supply force to the first support, second support and rigid substantially L-shaped support such that the carriage member of the rigid substantially L-shaped support maintains a substantially horizontal orientation throughout flexion and extension of the device.

In an implementation of the device, the device may include at least one truck frame support in active communication with the truck and the first end of the first support.

In an implementation of the device, the device may include at least one rear support frame in active communication with the truck, configured to support the second end of the first support member when the device is flexed.

In a typical implementation the truck frame support may extend across the truck frame and provide support to the first end of the first actuator.

In a typical implementation of the device, the device may include a control system including a pump and a series of valves connected to the actuators.

In a typical implementation the first, second, and/or third actuator may be a hydraulic cylinder, pneumatic cylinder, oil filled cylinders, piston and tube system, and/or a similar mechanical actuator.

In a typical implementation the actuators may be controlled by manual operation, computerized circuitry, and/or via use of the gyroscopic sensors. The control operations may allow the controller to maintain the carriage member of the rigid substantially L-shaped support in a substantially horizontal orientation. Thereby, any object on the carriage member would maintain a substantially horizontal orientation.

An advantage of the device is that it allows for the loading and/or unloading of an object from a truck, while the device is comprised of minimal parts and minimal weight. The advantages allows a user to efficiently transport objects and maintain control over the orientation of the objects during loading and unloading.

Other objects, advantages and capabilities of the present invention will become apparent from the following description taken in conjunction with the accompanying drawings showing the preferred embodiment of the present invention.

### BRIEF DESCRIPTION OF THE FIGURES

The present invention will best be understood with reference to the following detailed description, taken in conjunction with the accompanying figures, in which:

FIG. 1 illustrates a rear view of a preferred embodiment of the apparatus in accordance with the tenets and teachings of the present invention;

FIG. 2 illustrates a side view of a subassembly of the apparatus of FIG. 1;

FIG. 3 illustrates a side view of the apparatus of FIG. 1 in a retracted position;

FIG. 4 illustrates a side view of the apparatus of FIG. 1 in an extended position;

FIG. 5 illustrates a sequential series of views of the apparatus with the actuators removed, moving from the retracted position of FIG. 3 to the extended position of FIG. 4;

FIG. 6 illustrates a side view of the apparatus in a retracted position upon a truck;

FIG. 7 illustrates a side view of the apparatus in an extended position upon a truck;

FIG. 8 illustrates an isometric view of a truck support frame;

FIG. 9 illustrates an isometric view of a rear support frame;

FIG. 10 illustrates a system for controlling the device; and

FIG. 11 illustrates a side view of the apparatus correlating to the system for controlling the device in FIG. 10.

### DETAILED DESCRIPTION OF THE PRESENT INVENTION

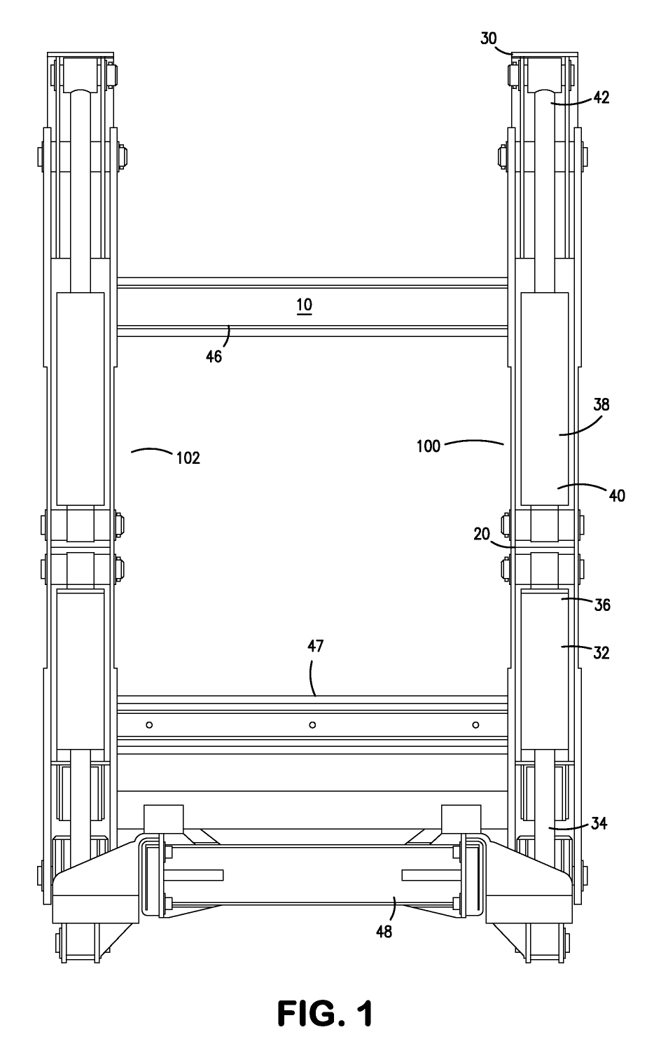

Referring to the Figures, wherein like reference numerals are used to identify identical components in the various views, FIG. 1 illustrates apparatus 10 including a right lifting subassembly 100 and left lifting subassembly 102, which are mirror images of one another, and are connected by a rear frame support 48, which extends between the subassemblies 100 and 102. Further, a backstop member 46 and a cross bar member 47 may connect the subassemblies' respective L-shaped supports (not shown in this view). Apparatus 10 may operate with the concurrent extension/retraction of subassemblies 100, 102.

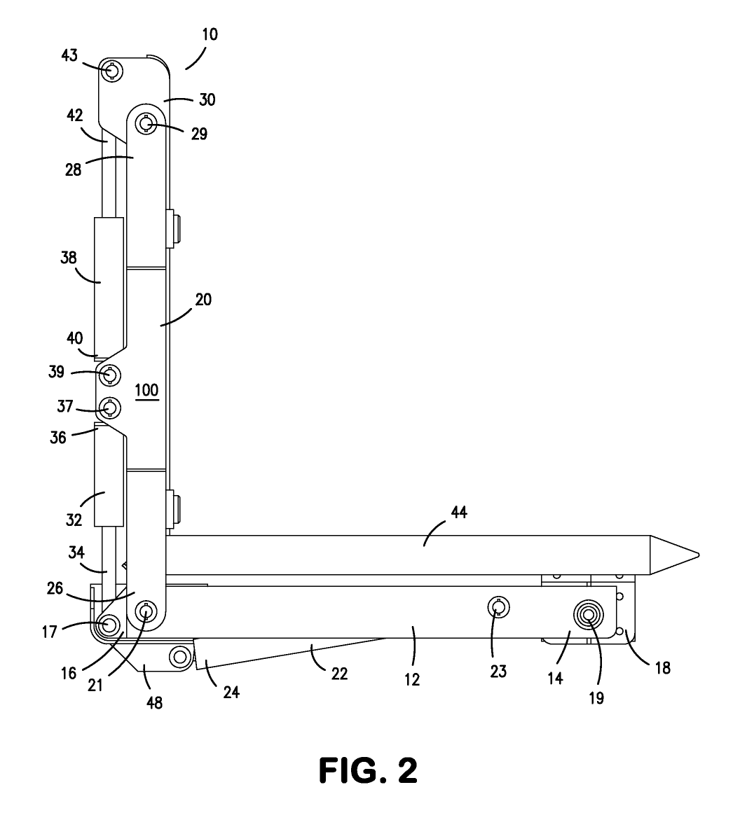

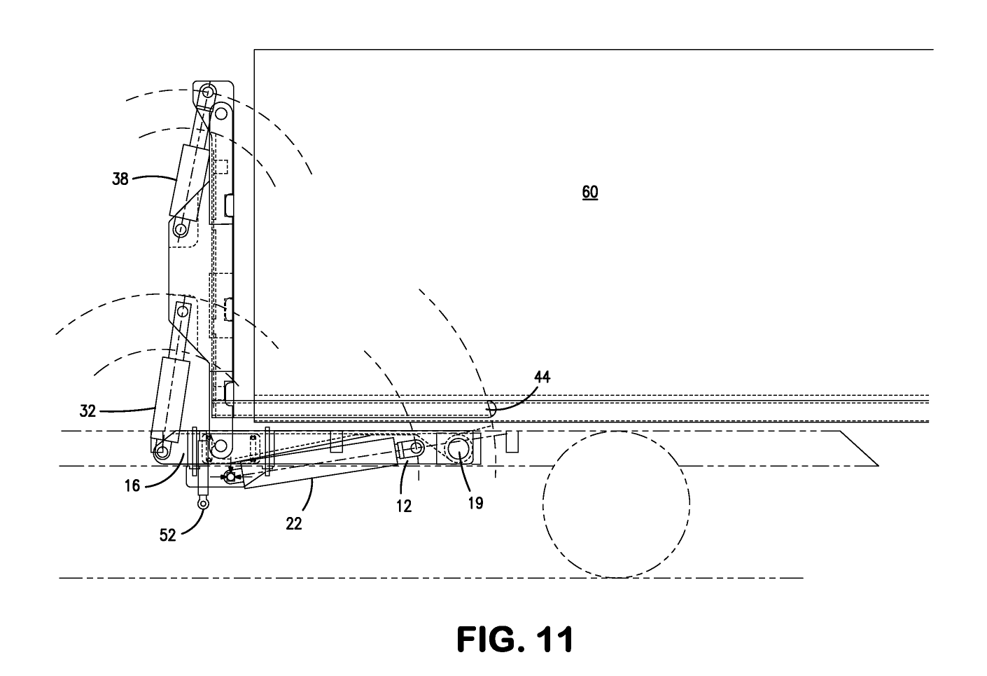

As illustrated in FIGS. 1 and 2, subassembly 100 includes a first support 12 having a first end 14 and a second end 16. First end 14 is preferably pivotally connected to a truck support frame 18 at pivot point 19. Pivot point 19 may be a pivot pin, screw and bolt system, system that allows for pivotal connections, and/or similar couplings. First end 14 is illustrated as pivotally connected to truck support frame 18. First end 14 may connect to a truck bed without the use of a truck support frame. Second end 16 of first support 12 is pivotally connected to second support 20 at pivot point 21. Pivot point 21 may be a pivot pin, screw and bolt system, system that allows for pivotal connections, and/or similar couplings. First actuator 22 is illustrated with first end 24, however, a second end is not visible in this view. First end 24 of first actuator 22 is pivotally connected to a rear support frame 48, which may be connected to a truck bed. First end 24 of the first actuator 22 may connect to a truck bed without the use of a rear support frame 48. Second end (not visible) of the first actuator 22 is pivotally connected to first end 14 of the first support 12 at pivot point 23. The first actuator 22 configuration allows for the first support member 12 to be lifted away from the truck bed and retracted to the truck bed. The first actuator 22 extends and provides force to pivot point 23, causing first support 12 to be lifted and rotated about pivot point 19, to where second end 16 is lifted away from the truck bed. Pivot point 23 may be located a specific distance from pivot point 19, allowing for rotation about pivot point 19, and such distance may include pivot point 23 being located above pivot point 19. The device may further include a boost actuator 52 (see FIG. 11), connected to second end 16 of first support 12, to support the rotating of first support 12 around pivot point 19. The first actuator 22 retracts and provides force to pivot point 23, causing first support 12 to be retracted and rotated about pivot point 19.

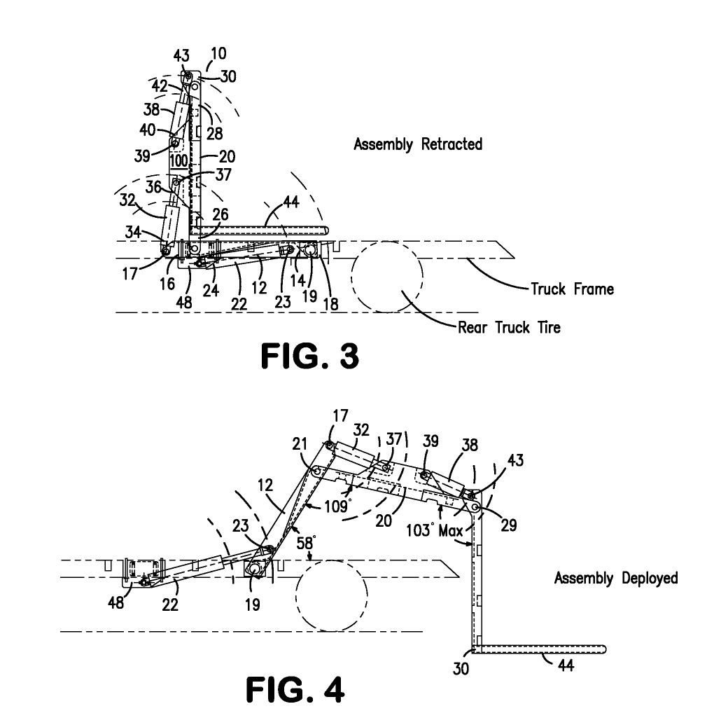

The second support 20 is illustrated with a first end 26 and second end 28. The first end 26 of second support 20 is pivotally connected to the second end 16 of first support 12 at pivot point 21. The second end 28 of second support 20 is pivotally connected to rigid, substantially L-shaped support 30 (see FIG. 3) at pivot point 29. Second actuator 32 is illustrated as having a first end 34 and a second end 36. First end 34 of the second actuator 32 is pivotally connected to the second end 16 of first support 12 at pivot point 17. The second end 36 is pivotally connected to second support 20 at pivot point 37. The second actuator 32 configuration allows for the second support 20 to be extended and retracted, while second actuator 32 maintains substantial alignment with second support 20. The second actuator extends and exerts force upon second support 20 at pivot point 37, causing second support 20 to rotate about pivot point 21. Similarly for retraction, the second actuator retracts and exerts force upon second support 20 at pivot points 37, causing second support 20 to rotate about pivot point 21.

Third actuator 38 is illustrated as having first end 40 and second end 42. The first end 40 is pivotally connected to the second support 20 at pivot point 39, and the second end 42 is pivotally connected with rigid, substantially L-shaped support 30 at pivot point 43. The third actuator 38 configuration allows for L-shaped support 30 to be controllably extended and retracted from first support 12 and second support 20, while third actuator 38 maintains substantial alignment with second support 20. Third actuator 38 exerts force to L-shaped member 30 at pivot point 43, causing L-shaped member 30 to pivot about pivot point 29. L-shaped support 30 includes carriage member 44, rigidly connected to a backstop member 46 (see FIG. 4).

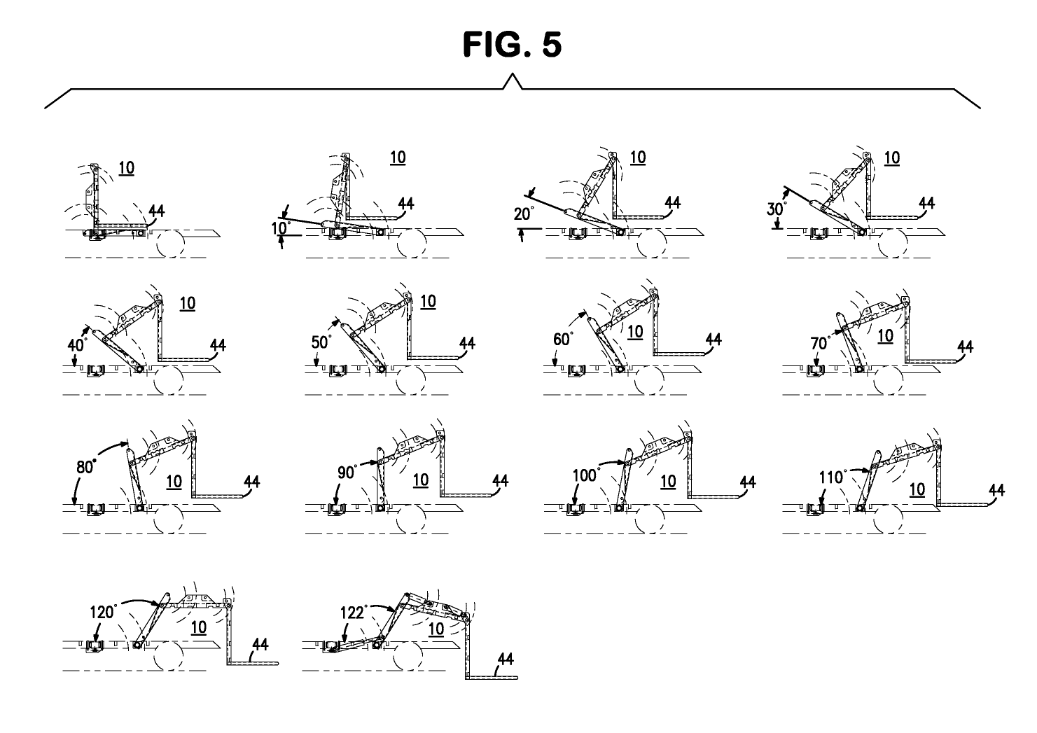

Referring now to FIGS. 3-4, the first support 12, second support 20, and L-shaped support 30 are illustrated in their respective orientations when the device is retracted (FIG. 3) and for when the device is extended (FIG. 4). Similarly, referring now to FIG. 5, apparatus 10 is shown in sequence moving from a retracted position to an extended position. For all positions in between retraction and extension the carriage member 44 is oriented substantially horizontally. First actuator 22, second actuator 32, and third actuator 38 operate in sequence and/or concurrently, allowing first support 12 to pivot about pivot point 19 and second support 20 to pivot about pivot point 21. Upon complete extension first support 12 may be at an obtuse angle in relation to the retracted position upon first support 12 on the truck bed. Concurrent to the operation of first actuator 22 and/or second actuator 23, third actuator 38 provides continuous, sufficient, and necessary force upon L-shaped member 30 at pivot point 43, causing carriage member 44 of L-shaped member 30 to maintain a substantially horizontal orientation until apparatus 10 reaches complete extension. Upon complete extension of apparatus 10 (see FIG. 4) the carriage member 44 may contact the ground for objects to be loaded thereon. The object being loaded upon carriage member 44 may have rollers configured to contact carriage member 44. The object being loaded upon carriage member 44 may be a platform with hollow tube runners configured to contact carriage member 44 and to have objects placed thereon.

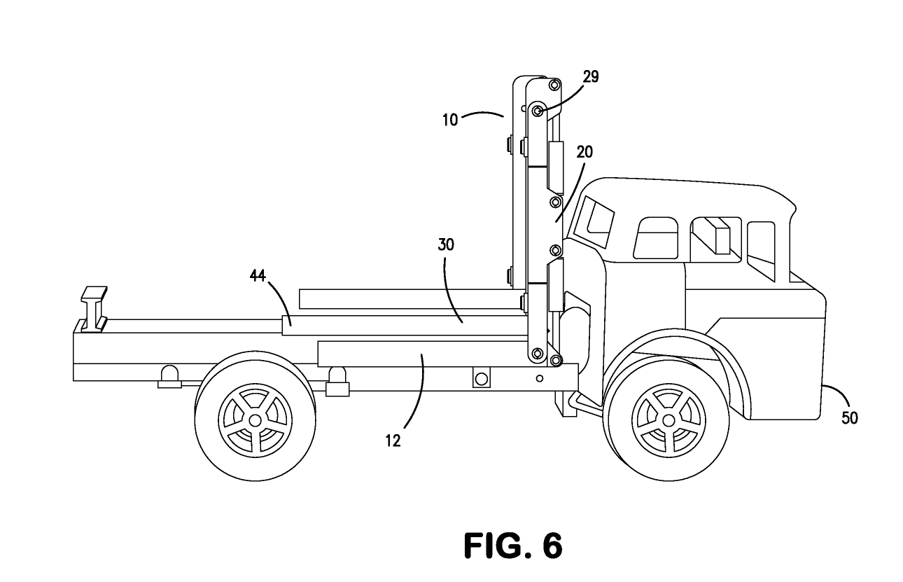

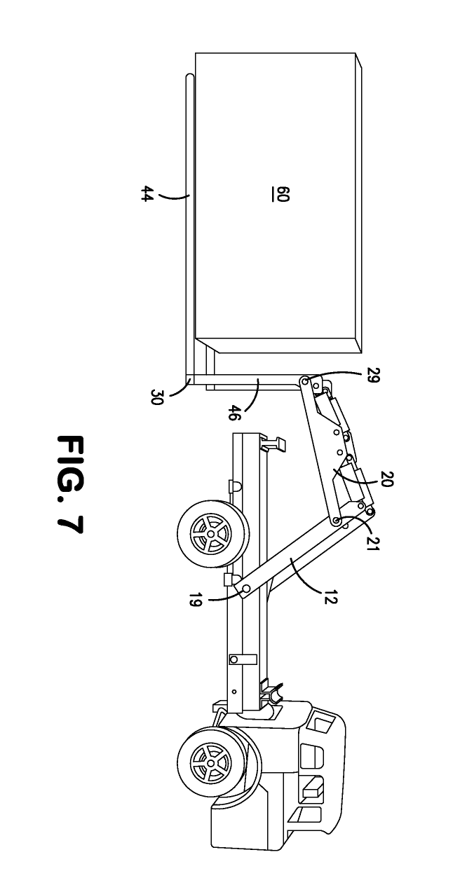

Referring now to FIGS. 6-7, the apparatus 10 is illustrated upon truck 50. The first support 12, second support 20, and L-shaped support 30 are illustrated in their respective orientations when the device is retracted (FIG. 6) and when the device is extended (FIG. 7). In FIG. 6, a load 60 is shown upon carriage member 44. The apparatus provides for carriage member 44, and vicariously load 60, to remain substantially horizontal as the apparatus is retracted from the extended position in FIG. 7 to the position shown in FIG. 6 through the operation of the first, second and third actuators.

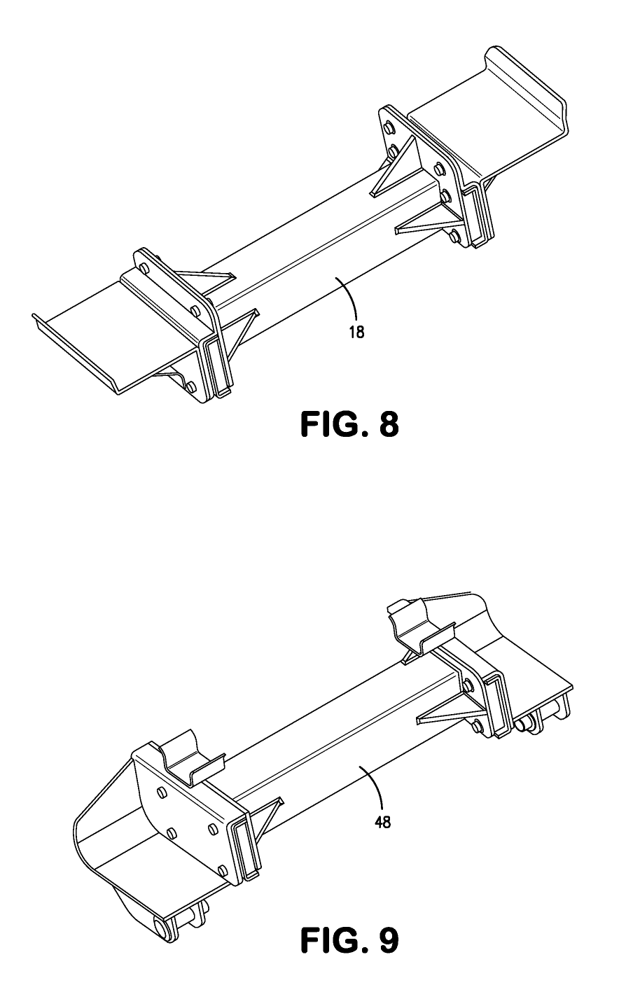

Referring now to FIGS. 8 and 9, the truck support frame 18 and rear support frame 48 are shown in an isometric view. Truck support frame 18 and rear support frame 48 may connect the device to a truck bed (see FIG. 2).

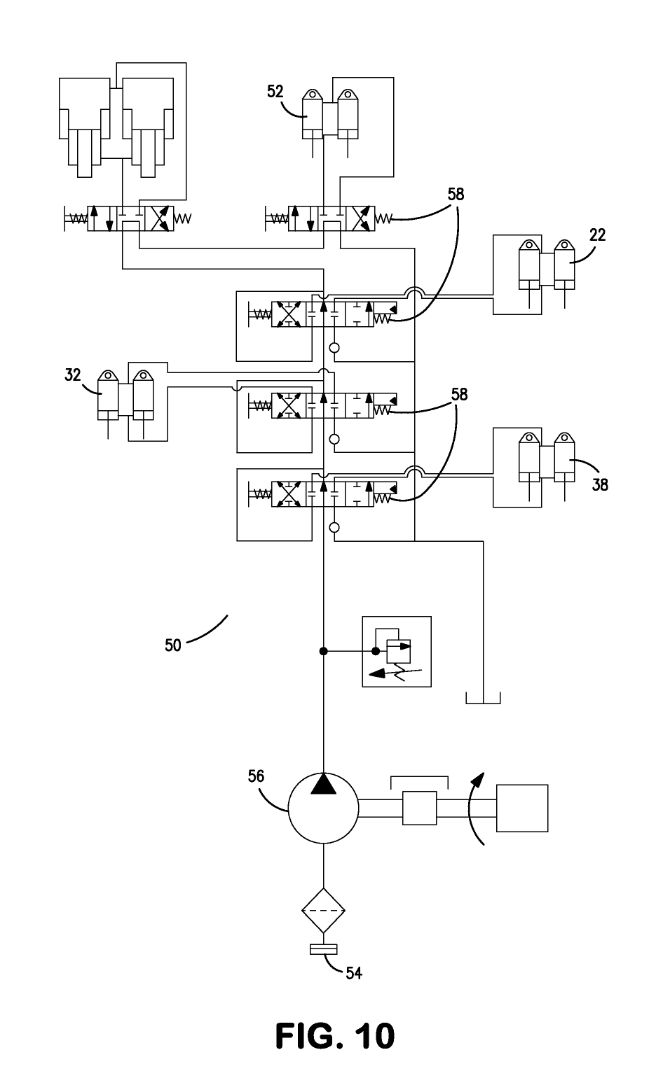

Referring now to FIGS. 10 and 11, a control system 50 causes the first actuator 22, second actuator 32, third actuator 38, and/or boost actuator 52 act together such that the carriage member 44 of the rigid L-shaped support, and load 60 thereon, is substantially horizontal through extension and retraction (see FIG. 5). Additional actuators may be included to allow the individual manipulation of the L-shaped support of subsystem 100 and the L-shaped support of subsystem 102, which may allow the lifting of objects from uneven grades. The actuators may utilize hydraulic fluid, or the like. The hydraulic fluid, or the like, may be housed in a reservoir 54 and supplied to the actuators by a pump 56. The hydraulic fluid, or the like, may travel from the reservoir 54 to the actuators through flexible hosing, which may further include control valves 58. It is preferred that the actuators are controlled through circuitry that is manipulatable manually and/or through a computer program. It is preferred that the circuitry communicate to gyroscopic sensors (not shown) to determine orientation.

While only those embodiments set forth above have been described in detail, other configurations and embodiments for the present invention may nevertheless exist that are within the spirit and scope of the present invention.

What is claimed is:

1. A device for loading and unloading objects onto a truck comprising:
a first subassembly having a first substantially L-shaped support connected to first actuators at pivot points;
a second subassembly having a second substantially L-shaped support connected to second actuators at pivot points in substantially the same arrangement as the first subassembly; and
at least one crossbar member connecting the first subassembly to the second subassembly;
wherein the first subassembly and second subassembly can concurrently act to lift objects on and off a truck bed while maintaining the object being lifted by the first and second L-shaped supports in a substantially horizontal orientation.

2. A device according to claim 1, including a support frame for mounting the first and second subassemblies on a truck bed.

3. A device according to claim 1, further including a control system connected to the first and second actuators.

4. A device according to claim 1, wherein the first subassembly and the second subassembly are mirror images of each other.

5. A device according to claim 1, wherein the first subassembly further includes a first support having a first end portion connected to a truck and a second end portion;
a first lift actuator configured to supply force to said first support having a first end portion connected to a truck and a second end portion connected to the first support; and
a second support having a first end connected to the second end portion of the first support and a second end connected to the first L-shaped support.

6. A device according to claim 5, wherein the second subassembly is a mirror image of the first assembly.

7. A subassembly for a device for loading and unloading objects onto a truck comprising:
a first support having a first end portion connected to a truck and a second end portion;
a first actuator configured to supply force to said first support having a first end portion connected to a truck and a second end portion connected to the first end portion of the first support;
a second support having a first end connected to the second end portion of the first support and a second end;
a second actuator configured to supply force to the second support having a first end connected to the second end of the first support, wherein said second actuator is in substantial alignment with said second support;
a rigid substantially L-shaped support configured to carry an object having a carriage member and a backstop member, the carriage member having a first end portion and a second end portion, and the backstop member having a first end portion and a second end portion; wherein the first end portion of the carriage member is in substantial rigid connection with the second end portion of the backstop member; and
a third actuator configured to supply force to the rigid substantially L-shaped support, having a first end portion and a second end portion, the first end portion of the third actuator connected to the second support and the second end portion of the third actuator connected to the first end of the backstop member,
wherein the first actuator, second actuator and third actuator supply force to the first support, second support and rigid substantially L-shaped support such that the carriage member of the rigid substantially L-shaped support maintains a substantially horizontal orientation.

8. The device of claim 1, further including at least one truck support frame connected to the truck and the first end of the first support.

9. The device of claim 1, further including at least one rear support frame connected to the truck, configured to support the second end of the first support member when the device is retracted.
